(19) United States
(12) Patent Application Publication
(10) Pub. No.: US 2026/0211431 A1
(43) Pub. Date: Jul. 23, 2026

(54) METHOD AND SYSTEM FOR MOVING AUTOMATED VEHICLES OF AN AUTOMATED STORAGE SYSTEM

(71) Applicant: AutoStore Technology AS, Nedre Vats (NO)

(72) Inventor: Erik Strømme, Borgen (NO)

(21) Appl. No.: 19/140,073

(22) PCT Filed: Dec. 19, 2023
(86) PCT No.: PCT/EP2023/086727

§ 371 Date: Jun. 17, 2025

(30) Foreign Application Priority Data
Dec. 21, 2022 (NO) 20221383

(51) Int. Cl. G05D 1/698; B61L 25/02; B61L 27/04; B61L 27/10; B65G 1/04; G05D 111/10

(52) U.S. Cl. CPC G05D 1/6987; B61L 25/02; B61L 27/04; B61L 27/10; B65G 1/0464; G05D 1/6985; G05D 2111/10

(57) ABSTRACT

A method and system for controlling movements of a plurality of automated vehicles (150) operating an automated storage and retrieval system (10) comprising a framework structure (100) and a rail system (108) configured to guide a plurality of automated vehicles (150) between storage columns (105) made by upright members (102) of the framework structure (100). The automated storage and retrieval system is controlled by a system controller (205), wherein each automated vehicle (150) comprises a vehicle body (310), first and second sets of wheels enabling lateral movement of the automated vehicles (150) in an X and Y direction on the rail system (108), components and parts connected to a local controller (320) enabling autonomous operation, a communication means connected to the local controller (320) for communicating with the system controller (205) and receiving movements instructions from the system controller (205), and a short-range communication device (330) configured to communicate signals with nearby automated vehicles (150). The method comprises the following steps: transmitting a control signal from the system controller (205) to at least two identified automated vehicles (150) to move as a group in same driving direction on the rail system (108); transmitting a control signal from the system controller (205) to a selected automated vehicle (150) in the group to act as a guiding automated vehicle (150) for other automated vehicles (150) in the group and to drive to a target position; transmitting a short-range signal from the selected guiding automated vehicle (150), signaling to other automated vehicles (150) in the group to follow the guiding automated vehicle (150); detecting the transmitted short-range signal by the automated vehicles (150) in the group; relaying detected short-range signals between the automated vehicles (150) in the group; driving the guiding automated vehicle (150) to the target position while transmitting movements signals from the short-range device (330) and let the other automated vehicles (150) in the group follow the movements of the guiding automated vehicle (150) as long as the transmitted movements signals are detected.

### FIELD OF THE INVENTION

The present invention relates to an automated storage and retrieval system for storage and retrieval of storage containers handled by automated vehicles, and more specifically to a method, system, and computer program for controlling movements of a plurality of automated vehicles to move as a group.

### BACKGROUND AND PRIOR ART

FIG. 1 discloses a prior art automated storage and retrieval system 10 comprising a framework structure 100 and automated vehicles 150 handling storage containers 106 on such a system.

The framework structure 100 comprises upright members 102 and a storage volume comprising storage columns 105 arranged in rows between the upright members 102. In these storage columns 105, storage containers 106 also known as bins, are stacked one on top of one another to form stacks 107 running in the Z-direction as shown in the figure. The upright members 102 may typically be made of metal, e.g. extruded aluminium profiles.

The framework structure 100 of the automated storage and retrieval system 10 comprises a rail system 108 that is arranged across the top of the framework structure 100. The rail system 108 may also be arranged below the framework structure 100. The automated vehicles 150 are then able to handle storage container in storage columns 105 from different levels in the Z-direction where the rail system 108 is installed.

A plurality of automated vehicles 150 can be operated to raise or lower containers 106 into the storage columns 105, and to transport the storage containers 106 above and below the storage columns 105. The rail system 108 comprises a first set of parallel rails 110 arranged to guide movement of the automated vehicles 150 in a first direction X across the top of the frame structure 100, and a second set of parallel rails 111 arranged perpendicular to the first set of rails 110 to guide movement of the automated vehicles 150 in a second direction Y, which is perpendicular to the first direction X. Where rails running in the X-direction meet rails running in the Y-direction there will be rails crossings, where the automated vehicles 150 can change direction.

Storage containers 106 stored in the columns 105 are accessed by the automated vehicles 150 through access openings 112 in the rail system 108.

Each automated vehicle 150 comprises a vehicle body and first and second sets of wheels which enable the lateral movement of the automated vehicles 150 in the X direction and in the Y direction, respectively. The vehicle body further comprises a plurality of mechanical components and electronic parts, such as transmitter, receiver, sensors, and power supply enabling autonomous operation.

For monitoring and controlling the automated storage and retrieval system 10, the system comprises a system controller 205 with a database keeping track of the location of each storage container 106 as well as which storage container 106 to be handled at any time. The system controller 205 will thus at all time have an updated overview of positions and movements of all automated vehicles 150 operating on the rail system 108. This is used for controlling traffic flow of all the automated vehicles 150 by transmitting movement instructions from the system controller 205 to the automated vehicles 150 for transporting specific storage containers 106 from one location to another location without colliding.

In addition to movement information, communication between the system controller 205 and the automated vehicles 150 also comprises status information transmitted from the automated vehicles 150 to the system controller 205. The status information may comprise current position and battery level as well as relevant data generated by sensors comprised in the automated vehicles 150. All communications between the system controller 205 and the automated vehicles 150 are performed via a wireless network which is exposed to interference and time delays.

When several automated vehicles 150 shall move in the same direction, the system controller 205 can control each automated vehicle 150 such that they are lined up in a train configuration, i.e. a plurality of automated vehicles 150 that are proximately arranged in series and arranged to move as a group. The assembly of the train is accomplished with help of sensors comprised in the automated vehicles 150 or by the system controller's knowledge about the automated vehicles'150 relative positions, or a combination of both. However, the position of an automated vehicle 150 on the rail system is not known with certainty until it has passed a rails crossing, after which the position of each automated vehicle 150 is transmitted to the system controller which processes this information. Updated position information may thus result in delays. In addition, further delays are expected, since position information is relayed through, and processed in the system controller 205. As a result, this may result in ineffective train driving for the automated vehicle 150.

WO 2022/106318 A1, the contents of which are incorporated herein by reference, describes a storage system, where the delay problem is avoided by letting a container handling vehicles drive in a “train” formation when in physical contact with each other. This is achieved by letting the last vehicle in the “train” drive a little faster than the vehicle in front thereby achieving physical contact.

The present solution provides an alternative way of driving automated vehicles as a group of vehicles driving in the same direction, i.e. driving in a “train” formation.

The solution is simple, efficient, and low cost and can easily be retrofitted and adapted to existing systems. In addition to addressing the mentioned delay problem, the solution requires less communication between a system controller and automated vehicles defined in a group driving in the same direction.

### SUMMARY OF THE INVENTION

The present invention is set forth and characterized in the independent claims, while the dependent claims describe other characteristics of the invention.

According to a first aspect, the invention is defined by a method of controlling movements of a plurality of automated vehicles operating an automated storage and retrieval system comprising a framework structure and a rail system configured to guide a plurality of automated vehicles between storage columns made by upright members of the framework structure. The rail system can be installed on top of the framework structure, below the framework structure, or inside the framework structure.

The automated storage and retrieval system is controlled by a system controller, wherein each automated vehicle comprises a vehicle body, first and second sets of wheels enabling lateral movements of the automated vehicles in an X and Y direction on the rail system, components and parts connected to a local controller enabling autonomous operation, a communication means connected to the local controller for communicating with the system controller and receiving movements instructions from the system controller, and a short-range communication device configured to communicate signals with nearby automated vehicles. The short-range communication device can be any device adapted for short range communication, such as a communication device using light for communication, or other devices with low power output not interfering radio communication between the system controller and the automated vehicles.

The first step of the method is transmitting a control signal from the system controller to at least two identified automated vehicles to move as a group in same driving direction on the rail system, and transmitting a control signal from the system controller to a selected automated vehicle in the group to act as a guiding automated vehicle for other automated vehicles in the group and to drive to a target position. A guiding automated vehicle communicates and receives control instructions from the system controller, while other automated vehicles in a group are controlled by the guiding vehicle, thereby reducing communication between each vehicle in a group and the system controller.

According to one embodiment, the transmission of a control signal from the system controller to the automated vehicles to move as a group comprises activating the short-range devices of the automated vehicles in the group.

According to one embodiment, the short-range devices are using a light source for communication. The light source may be visible light or IR-light. The visible light can be provided by LED light source, while IR-light can be provided by an IR-source.

The short-range communication device can in one embodiment be connected to each of four sides, extending parallel to one of the X or Y directions, of the vehicle body of each automated vehicle.

The next step is transmitting a short-range signal, e.g. an IR-signal, from the selected guiding automated vehicle, signaling to other automated vehicles in the group to follow the guiding automated vehicle. This is thus a movement signal. The IR-signal can be transmitted from an IR-transmitter facing the opposite direction of the driving direction of the guiding container vehicle.

The next step is detecting the transmitted short-range signals by the automated vehicles in the group. When using IR-sensors connected on each side of the vehicle body, a transmitted IR-signal is detected by the IR-sensor facing the driving direction of an automated vehicle which is in the group and next to the guiding automated vehicle.

Detected short-range signals are relayed between the automated vehicles in the group. This means that detected signals are forwarded to the signal sources facing the opposite direction of the driving direction of the automated vehicle in the group.

The guiding automated vehicle will then drive to the target position while transmitting the movements signals from the short-range device, and letting the other automated vehicles in the group follow the movements of the guiding automated vehicle as long as the transmitted movements signals are detected.

According to one embodiment, distances between automated vehicles in the group are measured, and the automated vehicles are controlled to drive at a set distance from each other.

Signals transmitted from the guiding automated vehicle may further define a number of grid cell the automated vehicles shall move before they stop.

The position of each automated vehicle in the group is in one embodiment determined from the position of the guiding automated vehicle as determined by the system controller, and measured distances between each following automated vehicle.

In one embodiment, identifications of and distances between automated vehicles are transmitted to the guiding container vehicle for forwarding this information to the system controller.

According to another embodiment, the automated vehicles are controlled to be in physical contact with each other, and where contact is confirmed when change in applied drive force is detected.

In one embodiment of the method, several logical groups are defined, each comprising multiple automated vehicles and where each group are controlled to move in a defined direction. In this embodiment, transmitted short-range signals are unique for each logical group. One group comprising for instance seven automated vehicles are instructed to move eight grid cells in the X-direction, while another group comprising five container handling vehicles are instructed to move six grid cells in the Y-direction.

The invention is further defined by a computer program product, that when being executed in local controllers of automated vehicles of an automated storage and retrieval system performs the method described above for moving a group of automated vehicles along a rail system of the automated storage and retrieval system.

According to a second aspect, the invention is defined by an automated storage and retrieval system comprising a plurality of automated vehicles operable to handle storage containers on a rail system configured to guide a plurality of automated vehicles between storage columns made by upright members of the framework structure.

The automated storage and retrieval system is controlled by a system controller, wherein each automated vehicle comprises a vehicle body, first and second sets of wheels enabling lateral movement of the automated vehicles in an X and Y direction on the rail system, components and parts connected to a local controller enabling autonomous operation, a communication means connected to the local controller for communicating with the system controller and receiving movements instructions from the system controller, a short-range communication device is configured to communicate signals with nearby automated vehicles. The system controller is configured to transmit a control signal to at least two identified automated vehicles to move as a group in same driving direction on the rail system, transmit a control signal to a selected automated vehicle in the group to act as a guiding automated vehicle for other automated vehicles in the group and to drive to a target position.

The local controller is configured to control transmission of a short-range signal from the short-range communication device to the automated vehicles in the group to follow the selected guiding automated vehicle, detect the short-range signal transmitted by the automated vehicles in the group, relay detected short-range signals between automated vehicles in the group, drive the guiding automated vehicle to the target position while transmitting movements signals from the short-range communication device, and control the automated vehicles in the group to follow the movements of the guiding automated vehicle as long as the transmitted movements signals are detected.

According to one embodiment, the short-range communication device is a light source, e.g. LED-light or IR-light.

In one embodiment, the short-range communication device is connected on a top part of a vehicle body to have a view in X and Y directions.

In another embodiment, the short-range communication device is connected to each of four sides, extending parallel to one of the X or Y directions, of the vehicle body of each automated vehicle.

According to a third aspect, the invention is defined by a computer program product that when being executed in local controllers of automated vehicles of an automated storage and retrieval system performs the method according to the first aspect of the invention for moving a group of automated vehicles along a rail system of the automated storage and retrieval system (10).

### BRIEF DESCRIPTION OF THE DRAWINGS

The following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a flowchart of a method for moving automated vehicles together as a group.

FIG. 3 illustrates the principle of controlling and moving automated vehicles together as a group.

FIG. 4 illustrates using IR-sensors as the light sources for controlling and moving automated vehicles together as a group.

### DETAILED DESCRIPTION OF THE INVENTION

In the following description, the invention will be explained in more detail by way of example only and with reference to the appended drawings. It should be understood, however, that the drawings are not intended to limit the invention to the subject-matter depicted in the drawings.

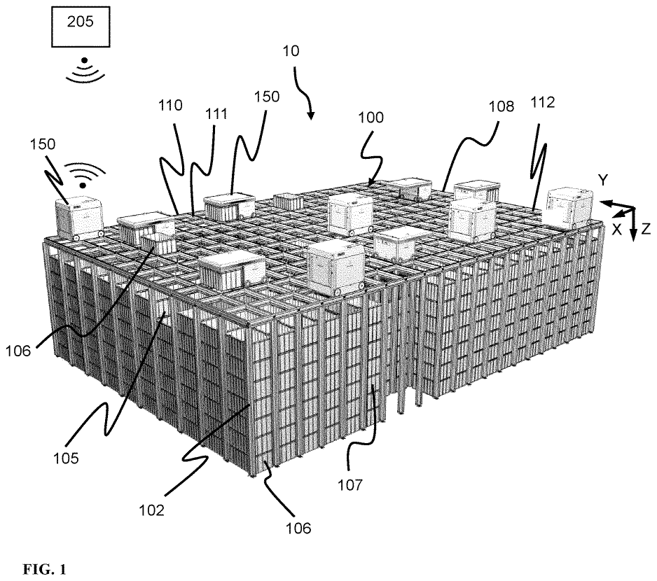

A typical prior art automated storage and retrieval system 10 with a framework structure 100 was described in the background section above with reference to FIG. 1.

The framework structure 100 can be of any size, and it is understood that it can be considerably wider and/or longer and/or deeper than the one disclosed in FIG. 1. For example, the framework structure 100 may have a horizontal extent of more than 700×700 storage columns 105 and a storage depth for storing more than eight stacked storage containers 106, and where storage containers 106 are handled by hundreds of automated vehicles 150 running on the rail system 108. The rail system may be installed on top of the framework structure 100 and/or in the middle of the framework structure 100, and/or below the framework structure 100. The automated vehicles will then be able to handle storage containers 106 in storage columns 105 from different positions in the Z-directions where the rail system is installed.

Also, the framework structure 100 can be considerably deeper than the one disclosed in FIG. 1. For example, the framework structure 100 may be more than eight grid cells 122 deep, i.e. in the Z-direction indicated in FIG. 1.

For monitoring and controlling the automated storage and retrieval system 10, a system controller 205 with a database keeps track of the location of each storage container 106 as well as which storage container 106 to handle at any time. The system controller 205 further controls each automated vehicle 150 by transmitting control instructions and receiving confirmation signals. The system controller 105 sends control instructions to each automated vehicle 150 to move from one grid cell 122 to another.

For larger systems comprising hundreds or even thousands of automated vehicles 150, real-time communication between automated vehicles 150 and the system controller 205 can be quite extensive and subjected to interference and delays. The quality of wireless communication is restricted by available bandwidth.

When two automated vehicles 150 are standing next to each other and both want to move in the same direction, the first automated vehicle 150 will start moving, but the other automated vehicle 150 has to wait for some time before it can move into the grid cell 122 previously occupied by the first automated vehicle 150. The waiting time introduces delays that will increase for each additional automated vehicle 150 that are next to each other and wants to move in the same direction.

The present solution addresses this and reduces delays and use of bandwidth requirement when several automated vehicles 150 are controlled to drive in same direction across the rail system. These are assigned to be in a same group and one of the automated vehicles 150 in the group is chosen as a group leader and guiding automated vehicle 150 for the other automated vehicles 150. The group leader will communicate with the system controller 205, while the other automated vehicles in the group are guided and controlled by the group leader.

The automated vehicle 150 can be of any type operating on an automated storage and retrieval system 10, such as an automated vehicle retrieving a storage container 106 from a storage columns 105 and transporting it to a destination location, or picking up a storage container and placing it in a storage column 105.

The automated vehicle 150 can also be drone transporting storage containers 106 between storage columns 105, or a harvester picking items picking and placing items in storage container 106. It can further be a service vehicle configured to perform service on other types of automated vehicles 150.

The different types of automated vehicles 150 can run on rail systems 108 installed in different levels of an automated storage and retrieval system, e.g. on top of the framework structure 100, in the middle of the framework structure 100, or below the framework structure 100.

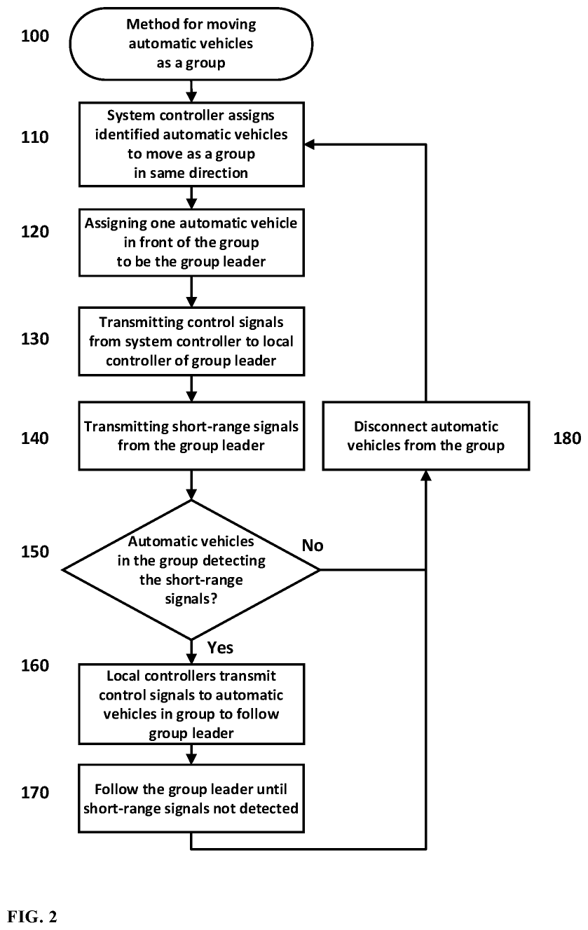

FIG. 2 is a flowchart of a method for moving automated vehicles together as a group 100. The system controller has an overview of every automated vehicles and their positions when operating the automated storage and retrieval system 10. When it is determined that several automated vehicles 150 shall drive in the same direction, the system controller assigns 110 identified automated vehicles 150 to move as a group in the same direction across the rail system 108.

One of the automated vehicles 150 in the group is assigned 120 to be a group leader that the other automated vehicles 150 in the group shall follow. Control signals, controlling movements to a target position on the rail system 108, are then transmitted 130 from the system controller 205 to the group leader.

Short-range signals are then transmitted 140 from the group leader. Automated vehicles 150 close to the group leader detecting the short-range signals 150 will forward the detected short-range signals to other automated vehicles 150 in the group. All automated vehicles 150 in a group will then follow the group leader if the short-range signals are detected 170.

The signals transmitted from the group leader may define how many grid cells 122 the automated vehicles 150 in the train shall move. After moving the defined number of grid cells 122, the automated vehicles 150 will disconnect from the group leader, meaning that the system controller will take control of each automated vehicle 150.

The number of grid cells 122 to move can be addressed to specific automated vehicles in the train. The signals may for instance specify that the first five automated vehicles 150 after the group leader shall move eight grid cells 122, while the three last vehicles shall move five grid cells 122.

Alternatively, the transmitted signal may only indicate that the automated vehicles 150 shall follow the group leader when the signal is detected. The automated vehicles 150 will then stop following the group leader once the short-range signal is not detected. The automated vehicles will then stop on the closest grid cell 122, and the system controller 205 will take control of each automated vehicle 150.

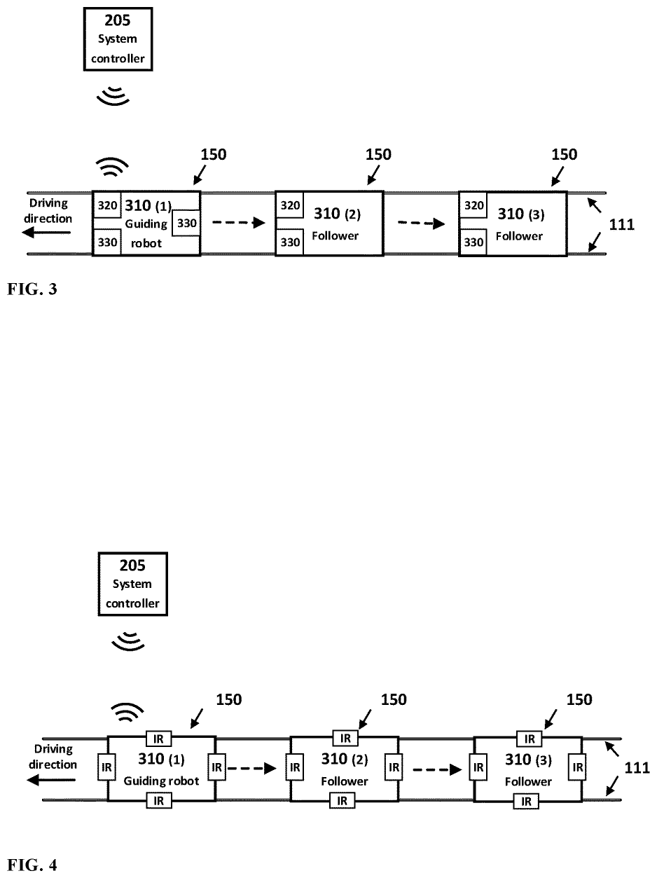

FIG. 3 illustrates the principle of controlling automated vehicles to move together as a group. In this example, three automated vehicles 150 are aligned as a train running on the same parallel rails 111.

When it is decided that the three automated vehicles 150 shall move together as a group, the system controller 205 sends a control signal to the three automated vehicles 150 identified with first, second and third vehicles bodies 310 (1), (2), (3). Since vehicle body 310 (1) is the first automated vehicle 150 in the driving direction, the system controller selects vehicle body 310 (1) to act as a group leader and guiding automated vehicle 150 for the two other vehicles of the train.

A short-range signal is transmitted from the short-range communication device 330 of the selected guiding automated vehicle 150, signaling to the two other automated vehicles 150 in the group to follow the guiding automated vehicle 150.

The short-range signal is detected by the second automated vehicle 150 with vehicle body 310 (2) next to the guiding automated vehicle 150 with vehicle body 310 (1).

Once detected, the received short-range signal is re-transmitted from the short-range communication device 330 of the second automated vehicle 150. The re-transmitted signal is detected by the third automated vehicle 150.

The train with all three automated vehicles 150 starts moving when the guiding automated vehicle 150 receives instructions from the system controller to move to a target position and starts transmitting movements signals from the short-range device 330. The two other automated vehicles 150 in the group will follow the movements of the guiding vehicle if the movement signals are detected.

FIG. 4 illustrates an embodiment of the solution, where IR-sensors, each comprising IR-transmitter and IR-receiver are used as the short-range device 330 for controlling automated vehicles 150 when moving together in a group. In the embodiment illustrated in this example, IR-sensors are connected to each of four sides of the vehicle body 310 of each automated vehicle 150. The IR-sensors may be connected to the outside of a vehicle body 310 or on the inside of a vehicle body 310. In this case, a sensor element may have a field of view through a small hole in the vehicle body 310.

For additional protection of the IR-sensor, the hole can be closed with a lid when the IR-sensor is inactive and open when the IR-sensor is active. Alternatively, an IR-sensor can be installed on top of an automated vehicle 150 having sensor zones perpendicular to the sides of a vehicle body 310, thereby pointing in X and Y directions.

The directivity of a light source such as LED-light or IR-light can be controlled by enclosing the source in a screen and using lenses for focusing the light.

The first steps of the method of this example are the same as for the basic principle described above with reference to FIG. 3. The three automated vehicles 150 with vehicles bodies 310 (1), (2), (3) are selected and assigned, by the system controller 205, to move together as a group in the same driving direction. If they are not already lined up on the same parallel rails 111, they are controlled to move from their current position to line up one after the other making a train configuration.

The IR-sensors connected to the automated vehicles 150 can stay active when the automated vehicles 150 are active, or the IR-sensors can be activated once automated vehicles 150 are assigned to move together as a group.

When the automated vehicles 150 assigned in the same group are lined up, the system controller 205 selects an automatic vehicle 150 in the group to act as a group leader. This will be the first automated vehicle 150 in a driving direction. The group leader will act as a guiding automated vehicle 150 which will receive instructions from the system controller 205 to drive to a target position on the rail system 108.

The target position will determine the driving direction for all automated vehicles 150 in the group.

Once the guiding automated vehicle 150 has received instructions to move to a target destination, its IR-transmitter having a detection zone in a direction opposite of the driving direction will transmit a “follow me” signal. In its simplest form, this can be to transmit IR-light either continuous, or as a blinking pattern. The transmitted IR-light is detected by the IR-sensor having a field of view at the guiding automated vehicle 150, i.e. the IR-sensor of the second automated vehicle 150 in the train configuration directed at the guiding automated vehicle 150. The detected “follow me” IR-signal is relayed to the IR-sensor pointing in the opposite direction of the driving direction of the second automated vehicle 150. The “follow-me” IR-signal is relayed from one automated vehicle 150 in the group to the following automated vehicle 150.

All the automated vehicles 150 in the group will follow the movements of the guiding automated vehicle 150 if the “follow me” IR-signal is detected. In this way all automated vehicles defined in same group will follow the guiding automated vehicle 150 driving in front of the train. Once the guiding automated vehicle 150 has reached its destination, it will stop transmission of the “follow me” IR-signal. The following automated vehicles 150 are then disconnected from the group, and the system controller 205 will take over control of these automated vehicles 150.

The IR-sensors can also be used to measure distance between two automated vehicles 150. IR-light that is transmitted from one automated vehicle 150 and reflected in another can be detected and distances can be estimated based on the time-of-flight principle. Additional sensors can also be used for more accurate measurements of distances.

Distance measurements can be used to control distances to be held between automated vehicles 150 when driving in a train configuration. Distance measurements can also be used for determining positions of automated vehicles 150 following a guiding automated vehicle 150 based on its current known position.

The IR-sensor can further be used for transferring information between automated vehicles 150 driving in train formation in same group. In this embodiment, identifications of and distances between automated vehicles are transmitted to the guiding container vehicle which can forward this information to the system controller.

The solution disclosed herein provides a simple and efficient way of driving several automated vehicles as a group in a train configuration. Short-range sensors, such as IR-sensors can be retrofitted and adapted to existing systems. Communication to and from the system controller 205 is reduced and delays that may occur, if the system controller 205 controls each automated vehicle 150 to move in a same direction, are avoided.

1.-20. (canceled)

21. A method of controlling movements of a plurality of automated vehicles operating an automated storage and retrieval system comprising a framework structure and a rail system configured to guide the plurality of automated vehicles between storage columns made by upright members of the framework structure, wherein the automated storage and retrieval system is controlled by a system controller, wherein each automated vehicle comprises a vehicle body, first and second sets of wheels enabling lateral movement of that automated vehicle in an X and Y direction on the rail system, components and parts connected to a local controller enabling autonomous operation, a communication means connected to the local controller for communicating with the system controller and receiving movements instructions from the system controller, and a short-range communication device configured to communicate signals with nearby automated vehicles; the method comprising:
transmitting a first control signal from the system controller to at least two identified automated vehicles to move as a group in a same driving direction on the rail system;
transmitting a second control signal from the system controller to a selected automated vehicle in the group to act as a guiding automated vehicle for other automated vehicles in the group and to drive to a target position;
transmitting a short-range signal from the guiding automated vehicle, signaling to other automated vehicles in the group to follow the guiding automated vehicle;
detecting the transmitted short-range signal by the automated vehicles in the group;
relaying detected short-range signals between the automated vehicles in the group; and
driving the guiding automated vehicle to the target position while transmitting movements signals from the short-range communication device and letting the other automated vehicles in the group follow the movements of the guiding automated vehicle as long as the movements signals are detected.

22. The method according to claim 21, where transmission of a control signal from the system controller to the automated vehicles to move as a group comprises activating the short-range communication devices of the automated vehicles in the group.

23. The method according to claim 21, comprising using a short-range communication device where a light source is used for communication.

24. The method according to claim 23, comprising using LED-light or IR-light as the light source.

25. The method according to claim 21, comprising connecting the short-range communication device to each of four sides, extending parallel to one of the X or Y directions, of the vehicle body of each automated vehicle.

26. The method according to claim 21, comprising aligning the automated vehicles in the group such that they are arranged as a train running on a same pair of tracks after each other with the guiding automated vehicle in front.

27. The method according to claim 26, comprising transmitting a light signal from a light source facing an opposite direction of the driving direction, from the guiding automated vehicle, and detecting the transmitted light signal, by a light sensor facing the driving direction of an automated vehicle in the group next to the guiding automated vehicle, and forwarding the detected light signal to the light source facing the opposite direction of the driving direction of the automated vehicle, and repeating detection and forwarding of the light signals to and from following automated vehicles in the group.

28. The method according to claim 27, comprising measuring distance between automated vehicles in the group and controlling the automated vehicles to drive at a set distance from each other.

29. The method according to claim 27, comprising transmitting light-signals defining number of grid cells to move for each automated vehicle in the train.

30. The method according to claim 26, comprising controlling the automated vehicles to be in physical contact with each other, and where contact is confirmed when a change in applied drive force is detected.

31. The method according to claim 28, where a position of each automated vehicle in the group is determined from a position of the guiding automated vehicle as determined by the system controller, and measured distances between each following automated vehicle.

32. The method according to claim 31, where identifications and distances between automated vehicles are transmitted to the guiding automated vehicle for forwarding this information to the system controller.

33. The method according to claim 21, comprising defining several logical groups each comprising multiple automated vehicles and directing each group to move in a defined direction.

34. The method according to claim 33, comprising transmitting short-range signals that are unique for each logical group.

35. An automated storage and retrieval system comprising a plurality of automated vehicles operable to handle storage containers on a rail system configured to guide a plurality of automated vehicles between storage columns made by upright members of a framework structure, the automated storage and retrieval system is controlled by a system controller, wherein each automated vehicle comprises a vehicle body, first and second sets of wheels enabling lateral movement of the automated vehicles in an X and Y direction on the rail system, components and parts connected to a local controller enabling autonomous operation, a communication means connected to the local controller for communicating with the system controller and receiving movements instructions from the system controller, and where a short-range communication device is configured to communicate signals with nearby automated vehicles, where the system controller is configured to:
transmit a control signal to at least two identified automated vehicles to move as a group in same driving direction on the rail system,
transmit a control signal to a selected automated vehicle in the group to act as a guiding automated vehicle for other automated vehicles in the group and to drive to a target position, and where the local controller is configured to:
control transmission of a short-range signal from the short-range communication device to the automated vehicles in the group to follow the guiding automated vehicle,
detect the short-range signal transmitted by the automated vehicles in the group,
relay detected short-range signals between automated vehicles,
drive the guiding automated vehicle to the target position while transmitting movements signals from the short-range communication device, and
control the automated vehicles in the group to follow movements of the guiding automated vehicle as long as the movements signals are detected.

36. The automated storage and retrieval system according to claim 35, where the short-range communication device is a light source used for communication.

37. The automated storage and retrieval system according to claim 36, where the light source is LED-light or IR-light.

38. The automated storage and retrieval system according to claim 35, where the short-range communication device is connected on a top part of a vehicle body to have a view in X and Y directions.

39. The automated storage and retrieval system according to claim 35, where the short-range communication device is connected to each of four sides, extending parallel to one of X or Y directions, of the vehicle body of each automated vehicle.

40. A computer program product, that when being executed in local controllers of automated vehicles of an automated storage and retrieval system performs the method according to claim 21 for moving a group of automated vehicles along a rail system of the automated storage and retrieval system.
